(19) United States
(12) Patent Application Publication
(10) Pub. No.: US 2010/0066150 A1
(43) Pub. Date: Mar. 18, 2010

(54) Seatbelt retractor

(75) Inventors: Takahiro Mori, Tokyo (JP); Takaaki Kimura, Tokyo (JP); Hideyuki Tonbe, Tokyo (JP); Masato Takao, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/458,144

(22) Filed: Jul. 1, 2009

(30) Foreign Application Priority Data
Sep. 16, 2008 (JP) 2008-236017

(51) Int. Cl. B60R 22/34; B60R 22/46

(52) U.S. Cl. 297/475; 242/390.2

(57) ABSTRACT

A seat belt retractor is provided with a reduced size and reduced man-hours required for installation to a vehicle body. A motor for rotating a spool of winding a seat belt and an ECU for the motor are united to form a combined motor/ECU unit. The motor/ECU unit is supported on a frame just below the spool. In this case, the motor and ECU are accommodated in a unit casing of which a casing body is flatly supported on a unit stay. The unit stay is supported by the frame.

### BACKGROUND

The present application relates to a technical field of a seat belt retractor in which a motor is used to wind and unwind a seat belt, to a technical field of a seat belt apparatus for a vehicle having the aforementioned seat belt retractor, and, more particularly to a technical field of a seat belt retractor and a seat belt apparatus further having a pretensioner.

Conventionally, for seat belt apparatuses installed in vehicles such as automobiles, there have been proposed various seat belt retractors which are provided with a pretensioner and in which the winding and unwinding of a seat belt is conducted by rotating a spool using a motor (see JP-A-2004-189024).

The pretensioner is required to wind up the seat belt for a predetermined amount by actuation at an initial stage in an emergency situation in which a deceleration larger than normal deceleration is applied to a vehicle during a vehicle collision or the like. In a seat belt retractor disclosed in JP-A-2004-189024, a connector of a gas generator for the pretensioner is located at a lower end of a frame of the seat belt retractor to ensure the operation amount of the pretensioner. A motor for rotating the spool is disposed below the connector.

As the pretensioner is disposed to extend to the lower end of the frame like the seat belt retractor disclosed in JP-A-2004-189024, there is no space for mounting the motor to the frame. Accordingly, it is difficult to design such an arrangement that the motor is supported directly by the frame. To solve this problem, in the seat belt retractor disclosed in JP-A-2004-189024, a supporting member is mounted to the lower end of the frame and the motor is supported at its both ends by the supporting member.

When the motor is supported by the supporting member mounted to the frame, however, there is another problem that the seat belt retractor greatly projects downwardly so that the apparatus becomes large. In addition, an electric control unit (ECU) for controlling the actuation of the motor must be disposed at another place of the vehicle body. Therefore, there is a problem that the wiring work between the motor and the ECU is complex so that man-hour requirement for mounting the seat belt retractor to the vehicle body is increased.

It would be advantageous to provide a seat belt retractor with a reduced size and which requires reduced man-hours for mounting the seat belt retractor to a vehicle body.

### SUMMARY

One disclosed embodiment relates to a seat belt retractor comprising: at least a spool for winding up a seat belt, a frame for rotatably supporting the spool; a motor for rotating the spool in a seat belt winding direction and a seat belt unwinding direction; and a power transmission unit for transmitting rotation of the motor to the spool. The seat belt retractor further comprises an electric control unit (ECU) for controlling the motor. The motor and the electric control are provided as a single combined motor/ECU unit. The motor/ECU unit is supported on the frame directly below the spool.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an illustration schematically showing a seat belt apparatus including a seat belt retractor according to an exemplary embodiment.

FIGS. 2(a)-2(c) show a seat belt retractor according an exemplary embodiment, wherein FIG. 2(a) is a view seen from the outside of a vehicle cabin, FIG. 2(b) is a view taken from the inside of the vehicle cabin, and FIG. 2(c) is a top view of the seat belt retractor.

FIG. 3(a) is a sectional view taken along a line IIIA-IIIA in FIG. 2(a), and FIG. 3(b) is a bottom view of the seat belt retractor shown in FIGS. 2(a)-2(c).

FIGS. 4(a)-4(c) are illustrations for explaining the operation of a pretensioner, wherein FIG. 4(a) is an illustration showing the pretensioner in the non-activated state, FIG. 4(b) is an illustration showing the pretensioner just after activated, and FIG. 4(c) is an illustration showing the pretensioner of which operation is terminated.

FIG. 5 is an exploded perspective view of a combined motor/ECU unit.

FIGS. 6(a)-6(d) show the combined motor/ECU unit, wherein FIG. 6(a) is a top view, FIG. 6(b) is a front view, FIG. 6(c) is a perspective view, and FIG. 6(d) is a sectional view taken along a line VID-VID in FIG. 6(a).

FIG. 7(a) is a left-side view of a power transmission unit with its cover removed, FIG. 7(b) is a left-side view of the power transmission retainer, and FIG. 7(c) is a right-side view of the power transmission retainer.

### DETAILED DESCRIPTION

According to an exemplary embodiment, a seat belt apparatus comprises at least a seat belt retractor for winding up a seat belt, a tongue slidably supported by the seat belt, and a buckle which is fixed to a vehicle body and to which the tongue can be detachably latched.

According to an exemplary embodiment, the seat belt retractor comprises: at least a spool for winding up a seat belt, a frame for rotatably supporting the spool; a motor for rotating the spool in a seat belt winding direction and a seat belt unwinding direction; and a power transmission unit for transmitting rotation of the motor to the spool. The seat belt retractor further comprises an electric control unit (ECU) for controlling the motor, in that the motor and the electric control unit are provided as a single motor/ECU unit, and in that the motor/ECU unit is supported on the frame directly below the spool.

The seat belt retractor may also include a pretensioner which rotates the spool in the seat belt winding direction using the force provided by gas generated by a gas generator in the event of an emergency, and in that the gas generator for the pretensioner is disposed above the spool and is supported by the frame.

According to an exemplary embodiment, the power transmission unit comprises a power transmission mechanism for transmitting the rotation of the motor to the spool with reducing the speed and a power transmission retainer for accommodating the power transmission mechanism. The power transmission retainer functions also as a casing for the pretensioner.

Furthermore, the motor/ECU unit has a unit casing that accommodates the motor and the electric control unit. The unit casing comprises a casing body having an upper opening, and a cover for closing the upper opening of the casing body. The casing body and the cover are each made of a thermal-conductive material having high thermal conductivity.

The motor and the electric control unit are provided as a single motor/ECU unit and can be mounted together to the frame of the seat belt retractor. Therefore, the installation of the seat belt retractor to the vehicle body is facilitated and the man-hour requirement for installation is reduced.

The motor and the electric control unit can be connected by wires and the wires can be arranged within a unit casing (i.e., the motor/ECU unit casing) before the seat belt retractor is installed in the vehicle body. The pre-assembly of the motor/ECU unit facilitates the installation of the seat belt retractor to the vehicle body and reduces assembly time and costs. The pre-assembly of the motor/ECU unit also reduces leakage of noises produced by the wires without shield member for exclusive use.

Further, the gas generator of the pretensioner is disposed above the spool, thereby preventing the pretensioner from greatly projecting downwardly. This allows a large space to be formed below the spool of the seat belt retractor so that this space can be used as an installation space for the motor and the electric control unit. Therefore, it is possible reduce the size of the seat belt retractor.

Further, the power transmission retainer functions also as the cover for the casing of the pretensioner, eliminating the need for an exclusive cover for the casing of the pretensioner. Therefore, it is possible to further reduce the number of parts and reduce the man-hour requirement for assembling the seat belt retractor.

Since the unit casing of the motor/ECU unit is made of a material with high thermal conductivity, heat expelled from the motor can be efficiently released outside through the unit casing even though the motor and the electric control unit are accommodated together in the unit casing. Therefore, the inner temperature of the unit casing can be prevented from increasing, reducing the likelihood the motor and the electric control unit will be affected by the heat.

Further, providing a more compact seat belt retractor for a seat belt apparatus, the seat belt retractor can be flexibly installed to the vehicle body, and the convenience of the seat belt apparatus installation can be increased.

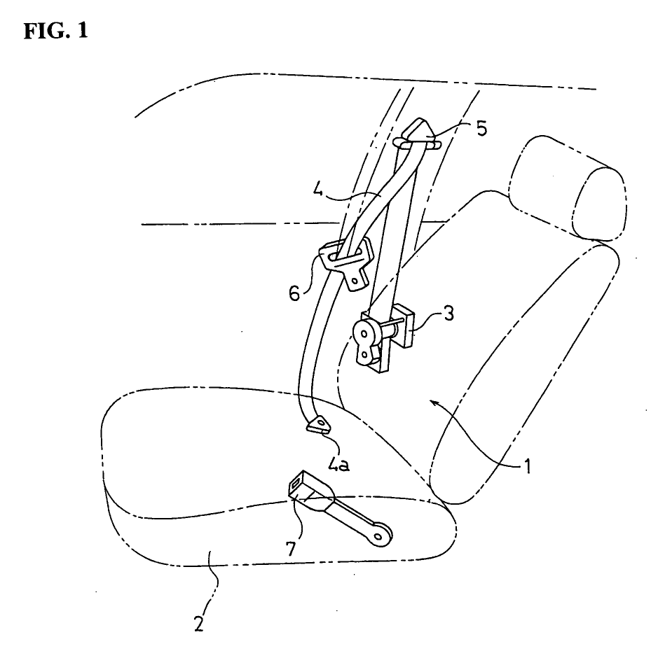

As shown in FIG. 1, according to one exemplary embodiment, the seat belt apparatus 1 is similar to a conventionally known seat belt apparatus of a three-point type in which a motor is used to wind or unwind a seat belt. The seat belt apparatus 1 includes a vehicle seat 2, a seat belt retractor 3 disposed near the vehicle seat 2, a seat belt 4 which is wound into the seat belt retractor 3 allowing the seat belt 4 to be unwound, a belt anchor 4a that is provided at the end of the belt 4 and is fixed to a vehicle floor or the vehicle seat 2, a deflection fitting 5 for guiding the seat belt 4 unwound from the seat belt retractor 3 toward an occupant's shoulder, a tongue 6 which is slidably supported by the seat belt 4 guided by and extending from the deflection fitting 5, and a buckle 7 that is fixed to the vehicle floor or the vehicle seat 2 and to which the tongue 6 can be inserted and detachably latched. The operation for fastening and unfastening such a seat belt apparatus 1 is well known.

The seat belt retractor 3 of this embodiment has a pretensioner and a motor. Similarly to a conventionally known pretensioner, the pretensioner is activated when a deceleration significantly larger than the deceleration during the normal driving is applied to the vehicle such as a vehicle collision and rotates a spool of the seat belt retractor 3 in the seat belt winding direction to wind up the seat belt 4 by a predetermined amount, thereby increasing the force for restraining the occupant. Further, similarly to a motor of the conventionally known seat belt retractor, the motor winds and unwinds the seat belt by rotating the spool.

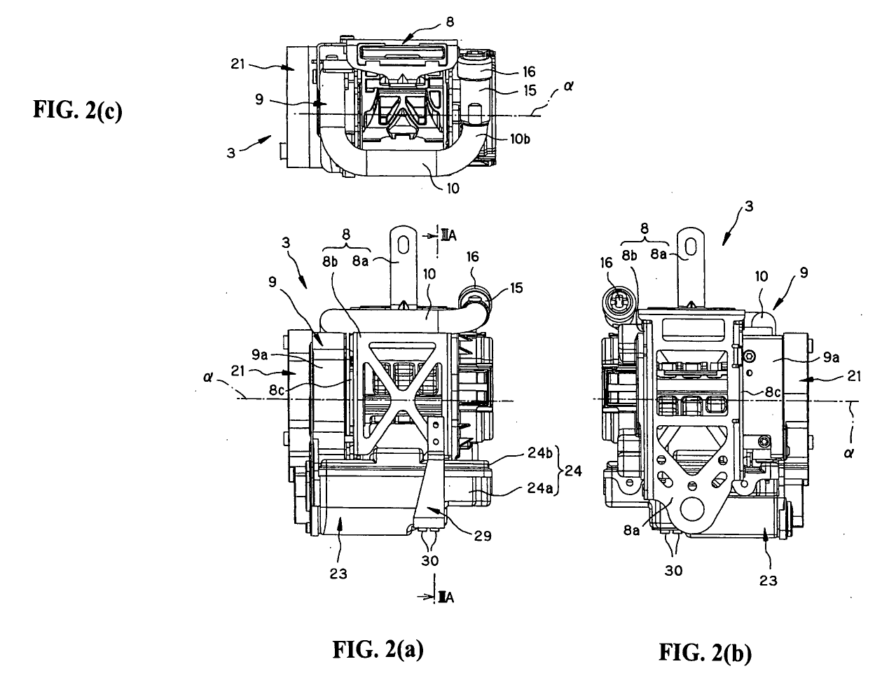

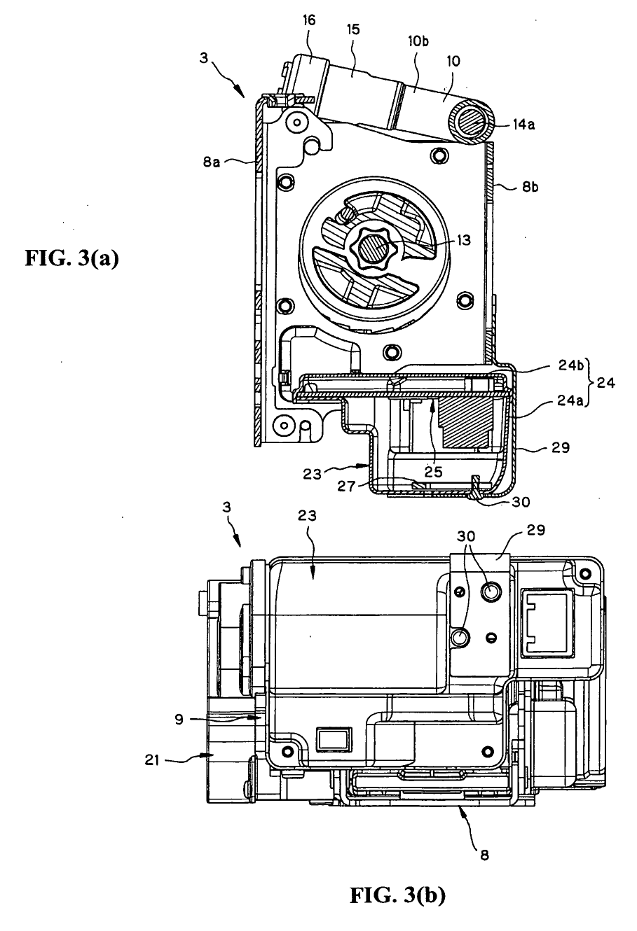

As shown in FIGS. 2(a) through 2(c), FIGS. 3(a) and 3(b), a frame 8 of the seat belt retractor 3 comprises a plate-like stay 8a to be fixed to the vehicle body and a U-like base 8b which is attached to the stay 8a and supports components of the seat belt retractor 3. The pretensioner 9 is attached to one of side walls 8c of the base 8b of the frame 8.

The pretensioner 9 may be similar to, for example, a pretensioner disclosed in Japanese patent application No. 2008-199753 filed by the present applicant. Since the details of the pretensioner 9 have been described in the specification and drawings of Japanese patent application No. 2008-199753, the pretensioner will be described briefly here.

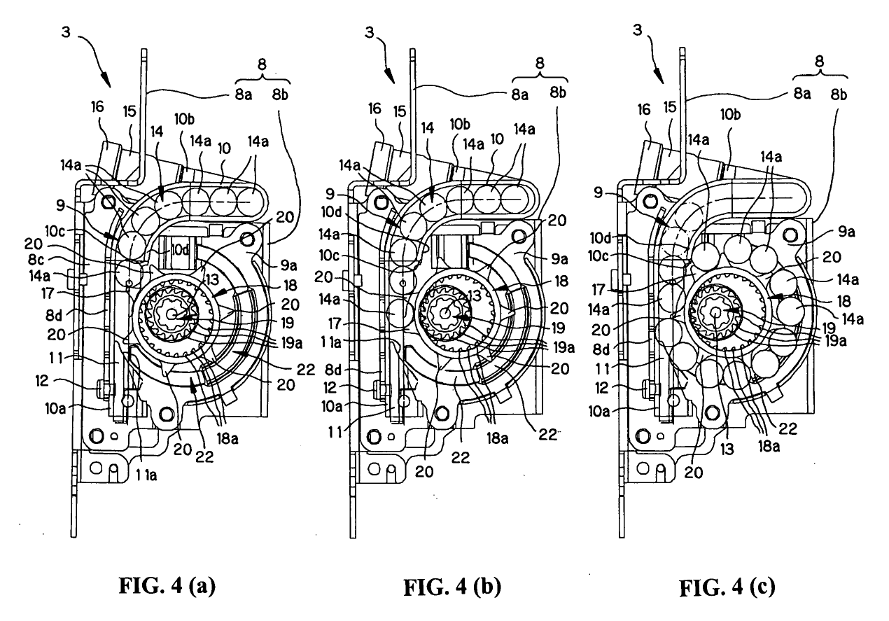

As shown in FIGS. 4(a) through 4(c), the pretensioner 9 has a pipe 10 of which a distal end 10a is closed by a plug 11. The distal end 10a of the pipe 10 and the plug 11 are fixed to a pipe mounting portion 8d formed in the side wall 8c of the base 8b by one or more fasteners 12 such as bolts and is positioned slightly below the spool (not shown) disposed coaxially with a rotary shaft 13. The rotary shaft 13 can rotate together with the spool.

In the pipe 10, a plurality of force transmitting members 14 (e.g., a plurality of balls 14a made of metal such as iron or aluminum and a piston, not shown) are movably arranged in the state being in contact with each other. In addition, a pipe-like pressure vessel 15 is connected to the proximal end 10b of the pipe 10. Disposed in the pressure vessel 15 is a gas generator 16 which produces a gas pressure that presses and moves the balls 14a.

The operation of the pretensioner 9 is similar to the operation of a conventionally known pretensioner using a plurality of balls, in that the pretensioner is activated in the event of emergency such as a vehicle collision in which a large deceleration is applied to a vehicle and thus rotates in the spool of the seat belt retractor 3 in the seat belt winding direction.

That is, as shown in FIG. 4(a), when the pretensioner 9 is not activated, the first one of the balls 14a is kept in contact with the lever 17 and the balls 14a following the first one are kept in contact with the adjacent balls 14a sequentially. During this, the gas generator 16 does not produce gas so that the balls 14a do not substantially press the lever 17. Therefore, the ring gear 18 is held in a state that its inner teeth 18a do not mesh with any of the external teeth 19a of the pinion 19.

In the event of emergency as mentioned above, the gas generator 16 is activated to produce gas so that a large pressing force is applied to the balls 14a by the gas pressure of the produced gas. By the pressing force transmitted through the first ball 14a, the ring gear 18 is rotated in the counterclockwise direction in FIG. 4(a). Then, as shown in FIG. 4(b), some of the internal teeth 18a of the ring gear 18 mesh with some of the external teeth 1 9a of the pinion 19 so that the pinion 19 starts to rotate in the same direction as that of the ring gear 18. Accordingly, the rotary shaft 13 i.e. the spool starts to rotate in the seat belt winding direction, thereby starting the winding of the seat belt 4 worn by the occupant.

As the first ball 14a is received between the levers 17 and 20 and the second ball 14a comes in contact with the lever 20 which is adjacent to the lever 17 in the clockwise direction, the ring gear 18 and the pinion 19 are further rotated together in the counterclockwise direction with the pressing force onto the lever 20 by the second ball 14a. At this point, the pressing force onto the lever 17 by the first ball 14a is substantially lost. Two balls, i.e. the second and third balls 14a are received between the lever 20 and the next lever 20 which is adjacent to the lever 20 in the clockwise direction. As the fourth ball 14a next to the third ball 14a comes in contact with the next lever 20, the ring gear 18 and the pinion 19 are further rotated in the counterclockwise direction with the pressing force on to the next lever 20 by the fourth ball 14a. At this point, the pressing force onto the lever 20 by the second and third balls 14a is substantially lost.

In a conventional pretensioner, after they have stop producing a pressing force onto levers, the balls exit from a cutout of the pipe, are spaced apart from the levers, and are stored into a ball storing chamber formed in the pretensioner. On the other hand, in the pretensioner 9 of this embodiment, no ball storing chamber is formed so that the first through third balls 14a are guided by an arc guide face 1 1 a of the plug 11 to escape from a cutout 10c of the pipe 10 after of they stop producing a pressing force onto the levers 17, 20. The balls 14a are moved to an arc guide passage 22 formed between a casing 9a and a power transmission retainer 21b of a power transmission unit 21 as will be described later.

With the pressing force onto the lever 20 which is sequentially adjacent to the former lever in the clockwise direction by the fourth or later ball 14a, the ring gear 18 and the pinion 19 continue to rotate in the counterclockwise direction. As shown in FIG. 4(c), the balls 14a which move into the arc guide passage 22 and which no longer provide substantial pressing forces onto levers are moved along the guide passage 22 according to the rotation of the ring gear 18 by the levers 17, 20 of the ring gear 18. As the first ball 14a comes in contact with a ball stopper 10d of the pipe 10, the first ball 14a is stopped and the rotation of the ring gear 18 is stopped. Therefore, the rotation of the pinion 19 is also stopped and the spool terminates the operation of winding up the seat belt 4. Because of the operation of winding up the seat belt 4 by the pretensioner 9, the force of restraining the occupant with the seat belt 4 is increased.

Since the rotation of the ring gear 18 is stopped, the second and later balls 14a are also stopped. At this point, the gas pressure of produced gas in the pipe 10 is low. As mentioned above, when all of the balls 14a are stopped, most of the balls 14a are in the arc guide passage 22 between the casing 9a and the power transmission retainer 21b. That is, most of the balls 14a are accommodated in the guide passage 22 (i.e., inside the casing 9a of the pretensioner 9) at the termination of the operation of the pretensioner 9.

In a state that the pretensioner 9 is mounted in a vehicle as shown in FIG. 4(a) through FIG. 4(c), the distal end 10a of the pipe 10 is set at the lowermost position so that the pipe 10 extends linearly upwardly from the distal end 10a. Further, as shown in FIG. 2(c), the pipe 10 is bent substantially at a right angle to a side opposite to a stay 8a at a position near the top of the base 8b of the frame 8 and extends linearly in a direction perpendicular to or substantially perpendicular to the central axis a of the spool and horizontally. Further, as shown in FIG. 2(a), the pipe 10 is bent substantially at a right angle to a side opposite to the base 8b in a direction parallel to the central axis a of the spool at a position near the end opposite to the stay 8a of the base 8b and extends linearly in a direction parallel to or substantially parallel to the central axis a of the spool and horizontally. Furthermore, as shown in FIG. 2(c), the pipe is bent substantially at a right angle to a side of the stay 8a at a position near the end opposite to the base 8b in a direction parallel to the central axis a of the spool and extends linearly in a direction slightly inclined upwardly relative to the direction perpendicular to or substantially perpendicular to the central axis a of the spool. Therefore, as shown in FIG. 2(b) and FIG. 3(a), the pressure vessel 15 and the gas generator 16 are disposed to face slightly upwardly above the base 8b. In this arrangement of the pipe 10, the pressure vessel 15 and the gas generator 16 are disposed above the spool to face to the inner side of the vehicle cabin (the upper side in FIG. 2(c) or the left side in FIG. 3(a)).

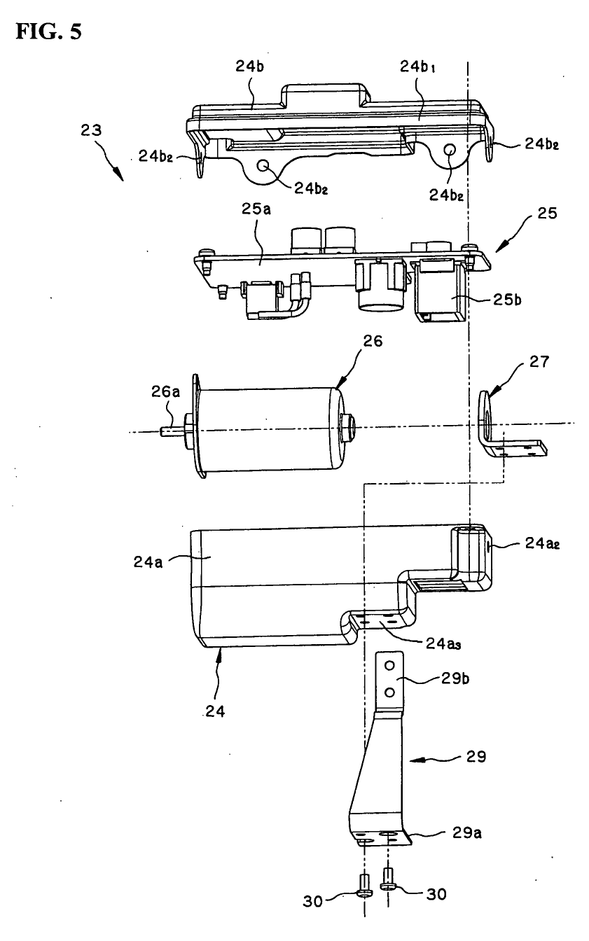

As shown in FIGS. 2(a), 2(b) and FIGS. 3(a), 3(b), a combined motor/ECU unit 23 is disposed directly below the pretensioner 9. As shown in FIG. 5, the motor/ECU unit 23 comprises a unit casing 24, an ECU 25, a motor 26, and a motor stopper 27.

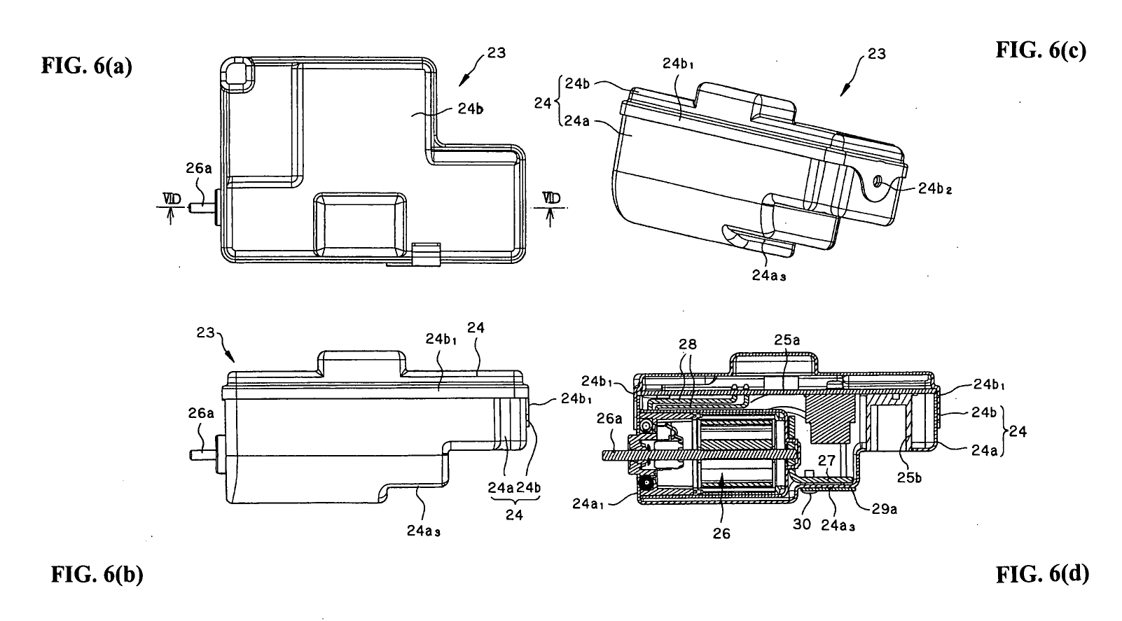

As shown in FIG. 5 and FIGS. 6(a) through 6(c), the unit casing 24 comprises a casing body 24a and a cover 24b. The casing body 24a and the cover 24b are both made of a conventionally-known material having high thermal conductivity such as a metal. As shown in FIG. 6(d), the casing body 24a is formed in a container-like shape of which upper side opens. The motor 26 is attached to an inner surface of the casing body 24a with adhesive agent. As the adhesive agent of this case, a conventionally-known adhesive agent having high thermal conductivity may be used. The motor 26 is held between a side wall 24a1 of the casing body 24a and the motor stopper 27 so that the motor 26 is aligned in the axial direction.

The cover 24b has a ring-like flange 24b1 which projects downwardly around the entire circumference of the cover 24b. The flange 24b1 is provided with a predetermined number (four, in the illustrated example) of mounting holes 24b2. The cover 24b is coupled to the casing body 24a to close the opening of the casing body 24a. In this state, the upper end portion of the casing body 24a is covered by the flange 24b1 of the cover 24b around the entire circumference of the casing body 24a.

The ECU 25 is disposed above the motor 26. The ECU 25 comprises an ECU substrate 25a and an ECU connector 25b which is electrically connected to the ECU substrate 25a and can be connected to an external device. The ECU 25 is mounted in the unit casing 24 such that the outer periphery of the ECU substrate 25a is sandwiched between the upper edge of the casing body 24a and the cover 24b and the connection port of the ECU connector 25b faces downwardly. In this case, the bottom of the casing body 24a is provided at a position corresponding to the ECU connector 25b with an opening which opens downwardly and allows the ECU connector 25b to be electrically connected to the external device. The motor 26 and the ECU substrate 25a are electrically connected via wires 28. The cover 24b is attached to the casing body 24a by inserting screws or bolts into mounting holes 24b2 of the cover 24b and screwing the screws or bolts into threaded holes 24a2 which are formed in the side walls of the casing body 24a and correspond to the mounting holes 24b2.

The motor/ECU unit 23 has a structure without opening at the upper side. The cover 24b has no penetrating opening except the mounting holes 24b2 formed in the flange 24b1 and the outer periphery of the upper end portion of the casing body 24a is covered by the annular flange 24b1 around the entire circumference. In addition, motor shaft 26a of the motor 26 projects outwardly from one end side of the motor/ECU unit 23.

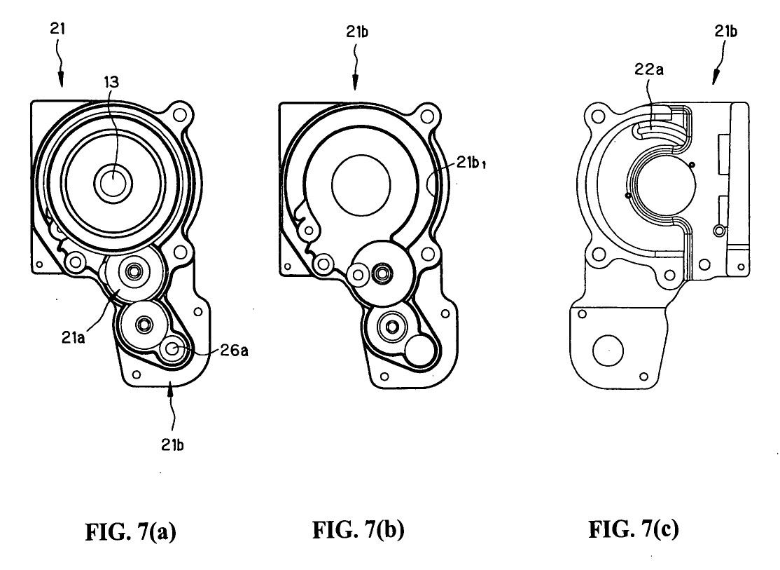

As shown in FIGS. 2(a) and 2(b), the power transmission unit 21 is disposed on a side of the pretensioner 9 opposite to the frame 8. As shown in FIG. 7(a), the power transmission unit 21 comprises a power transmission gear mechanism 21a, connecting the motor shaft 26a and the rotary shaft 13 which is rotatable together with the spool, and the power transmission retainer 21b. As shown in FIG. 7(b), the power transmission retainer 21b has a gear train receiving concavity 21b1 formed in one surface thereof, in which the power transmission gear mechanism 21a is accommodated. The power transmission gear mechanism 21a transmits rotation of the motor 26 from the motor shaft 26a to the rotary shaft 13 with reducing the speed. Therefore, the spool can be rotated by the rotation of the motor 26 both in the seat belt winding direction and the seat belt unwinding direction. In this case, the rotation of the motor 26 is controlled by the ECU 25. As shown in FIG. 7(c), a passage groove 22a as the arc guide passage 22 for the balls 14a of the aforementioned pretensioner 9 is formed in the other side (the side facing the pretensioner 9) of the power transmission retainer 21b. The power transmission retainer 21b is attached to one side wall 8c of the base 8b of the frame 8 together with the casing 9a of the pretensioner 9. In the seat belt retractor 3 of this embodiment, the power transmission retainer 21b functions also as a cover for the casing 9a of the pretensioner 9.

As shown in FIG. 2(a), a side of the motor/ECU unit 23 where the motor shaft 26a projects is fixed to the power transmission retainer 21b and a nearly center portion of the motor/ECU unit 23 is supported on the base 8b of the frame 8 via a unit stay 29. As shown in FIG. 5, the unit stay 29 is formed in a simple L-like shape and has a plate-like unit supporting portion 29a and a frame mounting portion 29b. A flat supported portion 24a3 of the casing body 24a is supported flatly (plane contact) by the unit supporting portion 29a (see FIG. 5). As shown in FIG. 6(d), the motor stopper 27 and the unit supporting portion 29a are fixed together by fasteners 30 such as bolts inserted into respective supporting holes formed in the motor stopper 27, the unit supporting portion 29a, and the casing body 24a, whereby the motor/ECU unit 23 is supported on the unit supporting portion 29a. The frame mounting portion 29b is mounted to the base 8b by fasteners such as bolts. In this manner, the motor/ECU unit 23 is flatly supported on the unit stay 29 at a position directly below the center of gravity.

According to the seat belt retractor 3 of this embodiment having the aforementioned structure, the pretensioner 9 is disposed such that the distal end 10a of the pipe 10 is located slightly below the spool and a proximal end 10b of the pipe 10 on the side of the gas generator 16 is located at the top of the frame 8, thereby preventing the pretensioner 9 from greatly projecting downwardly. This allows a large space to be formed below the spool of the seat belt retractor 3 so that this space can be used as an installation space for the ECU 25 and the motor 26. Therefore, it is possible to effectively reduce the size of the seat belt retractor 3 and install the ECU 25 and the motor 26 below the spool. Therefore, the motor/ECU unit 23 simply needs to be mounted to the frame 8, facilitating the installation of the seat belt retractor 3 to the vehicle body and reducing the man-hour requirement for installation.

Further, the motor stopper 27 for aligning the motor 26 in the axial direction and the unit supporting portion 29a of the unit stay 29 are fixed together via the casing body 24a, thereby reducing the number of parts and simplifying the structure of the motor/ECU unit. In addition, the motor/ECU unit is flatly supported by the unit supporting portion 29a, thereby stably supporting the motor/ECU unit 23. Therefore, the external force tolerance and the vibration resistance for supporting the motor/ECU unit 23 can be improved. Especially, the motor/ECU unit 23 is supported at a position directly below the center of gravity thereof, thereby further also as the cover for the casing 9a of the pretensioner 9, thereby allowing elimination of an exclusive cover for the casing 9a. Therefore, it is possible to further reduce the number of parts and reduce the man-hour requirement for assembling the seat belt retractor 3.

Since the unit casing 24 of the motor/ECU unit 23 is made of a material having good thermal conductivity such as a metal, heat expelled from the motor 26 can be efficiently released outside through the unit casing 24 even though the ECU 25 and the motor 26 are accommodated together in the unit casing 24. The increased heat transfer, therefore, prevent the inner temperature of the unit casing 24 from increasing to undesirable levels and affecting the performance of the ECU 25 and the motor 26.

The ECU 25 and the motor 26 can be previously connected by the wires 28 and the wires 28 can be arranged within the unit casing 24 before the installation of the seat belt retractor 3 to the vehicle body. The pre-assembly of the motor/ECU unit 23 facilitates the installation of the seat belt retractor 3 to the vehicle body and reduces assembly time and costs. The pre-assembly of the motor/ECU unit 23 also reduces leakage of noises produced by the wires 28 without shield member for exclusive use.

Further, the motor/ECU unit 23 is configured to not have and openings on the upper side. The connection port of the ECU connector 25b of the ECU 25 is arranged to face downwardly, the cover 24b of the unit casing 24 is provided with no opening which opens upward, and the upper end portion of the casing body 24a is covered by the flange 24b1 of the cover 24b around the entire circumference of the casing body 24a. Therefore, water is prevented from infiltrating into the unit casing 24, thereby effectively improving the respective drip-proofnesses of the ECU 25 and the motor 26.

The motor 26 and the ECU 25 are united, facilitating the installation to the vehicle body and allowing the motor/ECU unit 23 to be stably supported by the unit stay 29 increasing the flexibility in the arrangement and installation of the seat belt apparatus on the vehicle body.

The seat belt retractor and the seat belt apparatus can be preferably applied to a seat belt retractor which winds and unwinds a seat belt by means of a motor, a seat belt apparatus with such a seat belt retractor, and particularly preferably applied to a seat belt retractor further having a pretensioner and a seat belt apparatus with such a seat belt retractor.

The priority application, Japanese Patent Application No. 2008-236017, filed Sep. 16, 2008 including the specification, drawings, claims and abstract, is incorporated herein by reference in its entirety.

It should be understood that the present invention is not limited to the aforementioned embodiment and various design changes could be made within the range of features disclosed in patent claims. Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application.

What is claimed is:

1. A seat belt retractor comprising:
a spool for winding up a seat belt;
a frame for rotatably supporting the spool;
a motor for rotating the spool in a seat belt winding direction and a seat belt unwinding direction;
a power transmission unit for transmitting rotation of the motor to the spool;
an electric control unit (ECU) for controlling the motor, wherein the motor and the electric control are provided as a single motor/ECU unit, and wherein the motor/ECU unit is supported on the frame directly below the spool.

2. The seat belt retractor of claim 1, further comprising a pretensioner which rotates the spool in the seat belt winding direction using force provided by gas generated by a gas generator in the event of an emergency, wherein the gas generator for the pretensioner is disposed above the spool and is supported by the frame.

3. The seat belt retractor of claim 2, wherein the power transmission unit comprises a power transmission mechanism for transmitting the rotation of the motor to the spool with reducing the speed and a power transmission retainer for accommodating the power transmission mechanism, and the power transmission retainer functions also as a casing for the pretensioner.

4. The seat belt retractor of claim 1, wherein the motor/ECU unit has a unit casing, the motor and the electric control unit are accommodated in the unit casing, the unit casing comprises a casing body having an upper opening, and a cover for closing the upper opening of the casing body, and the casing body and the cover are each made of a thermal-conductive material having high thermal conductivity.

5. A seat belt apparatus comprising:
a seat belt;
a tongue slidably supported by the seat belt, and a buckle which is fixed to a vehicle body and to which the tongue can be detachably latched; and
a seat belt retractor comprising:
a spool for winding up a seat belt;
a frame for rotatably supporting the spool;
a motor for rotating the spool in a seat belt winding direction and a seat belt unwinding direction;
a power transmission unit for transmitting rotation of the motor to the spool;
an electric control unit (ECU) for controlling the motor, wherein the motor and the electric control are provided as a single motor/ECU unit, and wherein the motor/ECU unit is supported on the frame directly below the spool.
